(19) United States
(12) Patent Application Publication
(10) Pub. No.: US 2011/0302302 A1
(43) Pub. Date: Dec. 8, 2011

(54) ADAPTIVE MOBILE CLOUD SYSTEM USING PRIVATE VIRTUAL INTANCE AND CONSTRUCTION METHOD THEREOF

(75) Inventors: Ok Gee MIN, Daejeon (KR); Han Namgoong, Daejeon (KR)

(73) Assignee: ELECTRONICS AND TELECOMMUNICATIONS RESEARCH INSTITUTE, Daejeon (KR)

(21) Appl. No.: 13/152,532

(22) Filed: Jun. 3, 2011

(30) Foreign Application Priority Data
Jun. 4, 2010 (KR) 10-2010-0052999
Dec. 23, 2010 (KR) 10-2010-0133900

(51) Int. Cl. G06F 15/173; G06F 13/00; G06F 9/445; G06F 15/177

(52) U.S. Cl. 709/224

(57) ABSTRACT

An adaptive mobile cloud system using a private virtual instance (PVI) includes: a PVI automatic provisioning for generating a PVI by providing a hardware resource, an operating system and an application which are requested by a user terminal; a PVI image manager for storing and managing an image of an execution state of the PVI by checking a state of the PVI; a mobile interface adaptor that is adaptively operated according to an input/output device and resources of the user terminal; and an adaptive application manager for executing an application by adaptive cooperation between the user terminal and the PVI according to the resource of the user terminal.

### TECHNICAL FIELD

The present invention relates to a technique for constructing a mobile cloud, and more particularly, to a system for adaptive mobile cloud service using a private virtual instance (hereinafter, referred to as “PVI”) and a construction method thereof suitable for generating a PVI that maintains a user's software and an execution state thereof and for allowing equal access to the generated PVI through an Internet protocol television (IPTV), a personal computer (PC), a smart phone and the like.

### BACKGROUND OF THE INVENTION

Generally, in a cloud computing system, it is required to provide an independent virtual system to a user and manage the same. When the virtual system is provided to the user, a server needs to provide immediacy and scalability, and a user's usage environment needs to be maintained.

A conventional virtual system serviced by a cloud service provider is provided as will be described below. The cloud service provider allocates to a user a desired number of central processing units (CPUs), a desired memory size, a desired disc size and a desired network bandwidth based on a service level agreement (SLA), and the user selects an operating system. The cloud service provider generates an IP and a virtual system based on the user's selection, provides the generated IP and virtual system to the user, and receives the cost. Then, the user installs an application software on the virtual system and constructs usage environment.

Although the virtual system is provided to the user, it is still required for the user to install the application software on the virtual system and construct the usage environment suitable for the user as in the case of using a general hardware.

Further, it is difficult to ensure a private virtual system for the user under the circumstances in which the network connection between the user and the virtual system is unstable. Moreover, the cloud service provider needs to manage the virtual system without recognizing whether or not the virtual system is being used by the user and whether the network connection between the user and the virtual system is connected or disconnected.

Therefore, in the cloud computing system, a hardware resource, an operating system and an application software which are requested by the user according to the contract between the user and the SLA need to be provided together with the virtual system. Furthermore, the execution state of the virtual system needs to be maintained in order to ensure the private environment of the user even when the network is disconnected. Besides, it is required to allow access to the private virtual system through different terminal devices.

### DISCLOSURE

### Technical Problem

In view of the above, the present invention provides a method for constructing a private virtual instance (PVI) for maintaining a hardware resource, an operating system, an application software and a user's execution state based on a user's demand in a cloud computing system.

Further, the present invention provides an adaptive mobile cloud system using a PVI capable of uniquely managing the PVI and allowing equal access to the private virtual system through one or more types of terminals (IPTV, PC, smart phone and a mobile internet device (MID)) and a construction method thereof.

### Technical Solution

In accordance with an aspect of the present invention, there is provided an adaptive mobile cloud system using a private virtual instance (PVI) including: a PVI automatic provisioning for generating a PVI by providing a hardware resource, an operating system and an application which are requested by a user terminal; a PVI image manager for storing and managing an image of an execution state of the PVI by checking a state of the PVI; a mobile interface adaptor that is adaptively operated according to an input/output device and resources of the user terminal; and an adaptive application manager for executing an application by adaptive cooperation between the user terminal and the PVI according to the resource of the user terminal.

In accordance with an another aspect of the present invention, there is provided a method for constructing an adaptive mobile cloud system using a private virtual instance (PVI) including: driving a mobile interface adaptor adaptively according to input/output device and resources of a user terminal; generating a PVI by providing a hardware resource, an operating system and an application which are requested by the user terminal; storing and managing an image of an execution state of the PVI by checking a state of the PVI; and executing an application by adaptive cooperation between the user terminal and the PVI according to the resources of the user terminal.

### Advantageous Effects

In accordance with the present invention, when a virtual system is used in a cloud system, a user is provided with a private virtual computer containing a desired application software by only a simple selection without an effort to install the application software, and the private virtual instance can be maintained without damage even when a network is unstable or abnormally terminated.

Moreover, a user can use a private virtual computer by accessing the same computer through various types of terminals without transferring data or changing execution environment.

Hence, a telework can be implemented while having an environment same as that of the office, since an operation can be performed anytime and anywhere by accessing the private virtual instance installed in the cloud system such as a mobile cloud center.

### BRIEF DESCRIPTION OF THE DRAWINGS

The objects and features of the present invention will become apparent from the following description of embodiments, given in conjunction with the accompanying drawings, in which:

FIG. 1 shows a private virtual instance (PVI) in accordance with an embodiment of the present invention;

FIG. 2 is a block diagram showing a structure of an adaptive mobile cloud system using the PVI in accordance with the embodiment of the present invention;

FIG. 3 is a flowchart showing an operation performed on a user terminal by a mobile interface adaptor shown in FIG. 2;

FIG. 4 is a flowchart showing an operation for provisioning a PVI which is performed by a PVI automatic provisioning shown in FIG. 2;

FIGS. 5a and 5b are flowcharts showing operations of a PVI image manager shown in FIG. 2; and

FIG. 6 shows a method in which the application software is executed cooperatively between the user terminal and the PVI depending on a type of a determined terminal in accordance with the embodiment of the present invention.

### BEST MODE FOR THE INVENTION

Embodiments of the present invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

In the following description of the present invention, if the detailed description of the already known structure and operation may confuse the subject matter of the present invention, the detailed description thereof will be omitted. The following terms are terminologies defined by considering functions in the embodiments of the present invention and may be changed operators intend for the invention and practice. Hence, the terms should be defined throughout the description of the present invention.

Combinations of respective blocks of block diagrams attached herein and respective steps of a sequence diagram attached herein may be carried out by computer program instructions. Since the computer program instructions may be loaded in processors of a general purpose computer, a special purpose computer, or other programmable data processing apparatus, the instructions, carried out by the processor of the computer or other programmable data processing apparatus, create devices for performing functions described in the respective blocks of the block diagrams or in the respective steps of the sequence diagram. Since the computer program instructions, in order to implement functions in specific manner, may be stored in a memory useable or readable by a computer aiming for a computer or other programmable data processing apparatus, the instruction stored in the memory useable or readable by a computer may produce manufacturing items including an instruction device for performing functions described in the respective blocks of the block diagrams and in the respective steps of the sequence diagram. Since the computer program instructions may be loaded in a computer or other programmable data processing apparatus, instructions, a series of processing steps of which is executed in a computer or other programmable data processing apparatus to create processes executed by a computer so as to operate a computer or other programmable data processing apparatus, may provide steps for executing functions described in the respective blocks of the block diagrams and the respective steps of the sequence diagram.

Moreover, the respective blocks or the respective steps may indicate modules, segments, or some of codes including at least one executable instruction for executing a specific logical function(s). In several alternative embodiments, it is noticed that functions described in the blocks or the steps may run out of order. For example, two successive blocks and steps may be substantially executed simultaneously or often in reverse order according to corresponding functions.

An embodiment of the present invention constructs a private virtual instance (PVI) for maintaining a hardware resource, an operating system, an application software and a user's execution state in accordance with a user's demand in a mobile cloud computing system, manages the constructed PVI uniquely, and allows equal access to the PVI through one or more types of terminals (IPTV, PC, smart phone, MID and the like).

Here, the PVI provides an instance in which an application is installed in accordance with a user's demand, unlike a conventional virtual machine (VM), and serves as a user's unique space that can be seen and executed adaptively according to performance of an access terminal and an input/output device.

Hereinafter, the embodiment of the present invention will be described in detail with reference to the accompanying drawings.

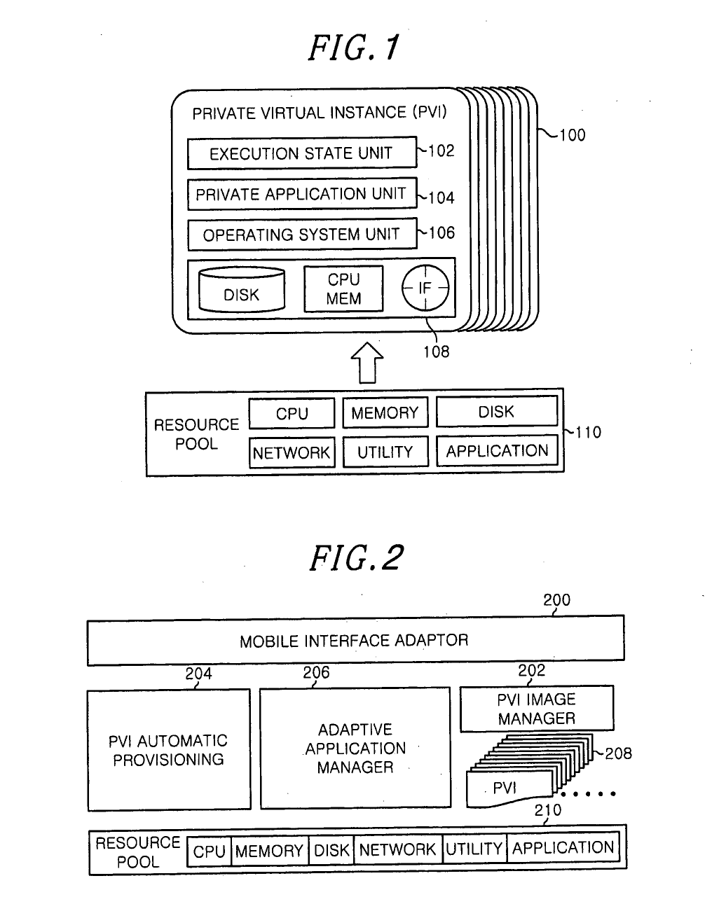

FIG. 1 shows a PVI in accordance with an embodiment of the present invention.

Referring to FIG. 1, a PVI 100 provides a package of a hardware resource, an operating system, a required application software, an execution state and the like. The PVI 100 includes an execution state unit 102, a private application unit 104, an operating system unit 106, and a hardware resource 108.

Generally, a hardware resource and a user-selected operating system are provided on a private virtual machine, and the virtual machine is managed by a user. The PVI 100 of the present invention performs provisioning of the hardware resource 108 and the operating system unit 106, similar to the virtual machine. In addition, the PVI 100 performs provisioning of an application or a service selected by a user through the private application unit 104, and provides a user instance received from a resource pool 110 including a CPU, a memory, a disc, a network, utilities, and an application software.

Further, the PVI manages the execution state unit 102 for providing a private virtual system that is not damaged even when reconnection occurs after user's abnormal shutdown.

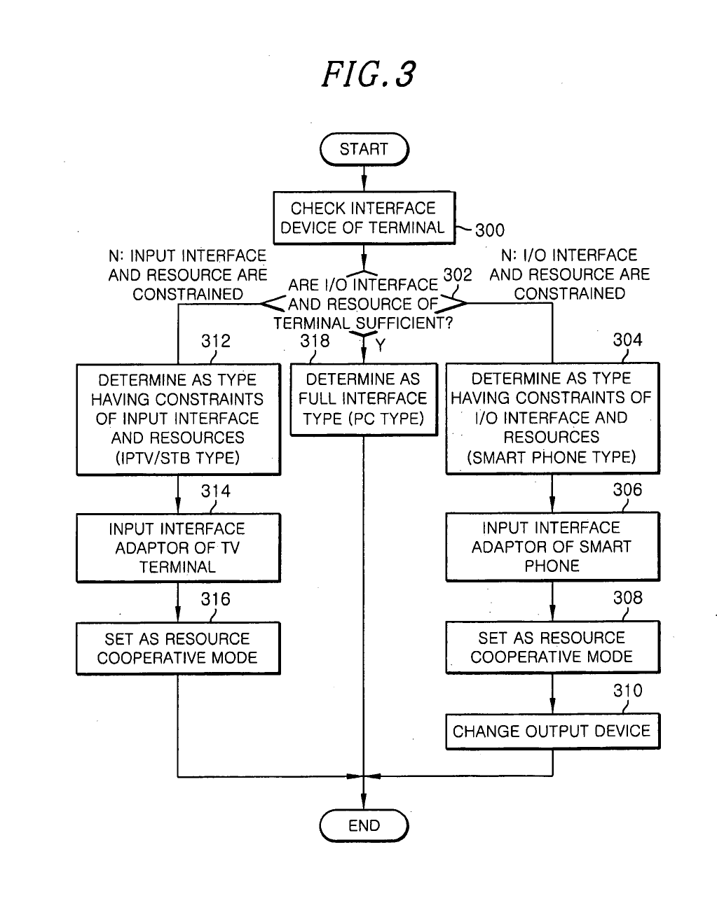

The PVI 100 shown in FIG. 1 is managed and processed by a system structure shown in FIG. 2 so that it can be maintained without damage and provided adaptively according to types of terminals.

FIG. 2 is a block diagram showing a structure of an adaptive mobile cloud system using the PVI in accordance with the embodiment of the present invention.

Referring to FIG. 2, the adaptive mobile cloud system includes a mobile interface adaptor 200, a PVI image manager 202, a PVI automatic provisioning 204, an adaptive application manager 206, a private virtual instance 208 and a resource pool 210.

The mobile interface adaptor 200 checks an input/output (I/O) device of a user terminal and determines a resource state of the user terminal (which resource is provided in the user terminal). Moreover, the mobile interface adaptor 200 can automatically recognize different I/O devices of a plurality of heterogeneous terminals owned by a user and adapt an interface thereto.

The PVI image manager 202 checks the states of the PVIs 208 on a user basis and stores images of the execution states thereof. The PVI image manager 202 provides the stored image when reconnected later. Therefore, when reconnection (n^{th} connection) occurs, the last execution state of the PVI 208 of previous connection (n−1^{th} connection) is identified using a stored image and thus a state of the user terminal can be analyzed. The PVI image manager 202 stores the images of PVIs 208 by monitoring and classifying the states of the PVIs, e.g., stop, pause, operation, abnormal disconnection, and long-term non-usage. When a user is reconnected, the PVI image manager 202 analyzes the user terminal and provides a PVI 208 adapted to a type and performance of the user terminal.

The PVI automatic provisioning 204 generates and provides a PVI on a user basis in accordance with a user's demand.

The adaptive application manager 206 performs adaptive cooperation between terminals and PVIs 208 based on the terminal state in the mobile interface adaptor 200. In other words, in order to allow a user to access the same PVI 208 through a plurality of heterogeneous terminals owned by the user, the applications in the PVI 208 are automatically distributed to the terminals and the PVIs 208 and cooperatively executed according to the performance of the user terminals.

The resource pool 210 monitors computer resources of the system and manages a CPU, a memory, a hard disc, a network bandwidth, utilities and an application software license which are currently available. Moreover, the resource pool 110 distributes resources by a user's demand.

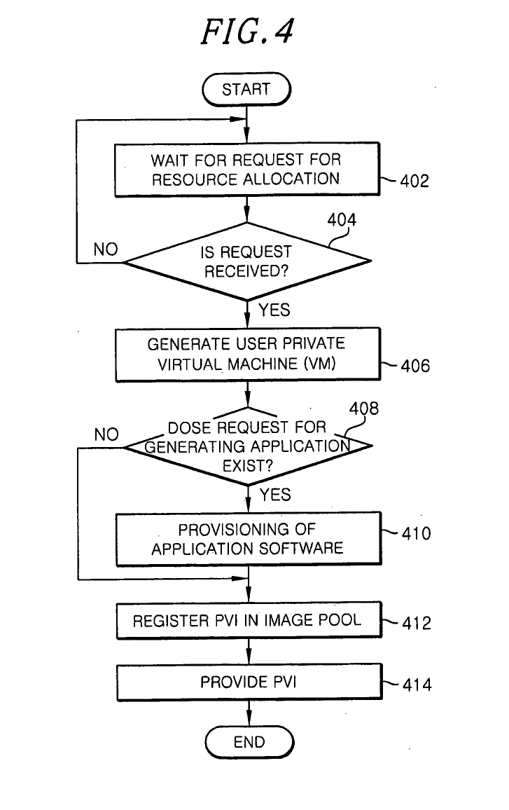

FIG. 3 is a flowchart showing an operation performed on a user terminal by a mobile interface adaptor shown in FIG. 2.

Referring to FIG. 3, in step 300, the mobile interface adaptor 200 identifies an I/O interface device of a user terminal accessing thereto. Then, in step 302, whether or not the resource is sufficient is determined by checking the I/O device of the user terminal.

If it is determined in the step 302 that the I/O resource and other resources (e.g., calculation ability, battery and the like) are constrained, the process proceeds to step 304 and determines the user terminal as a type having constraints of an I/O interface and resources (e.g., as a smart phone type). Next, in step 306, an input interface adaptor of the user terminal, i.e., of the smart phone is driven. Then, in step 308, the user terminal is set to a resource cooperative mode. In step 310, the output device of the user terminal is changed. Herein, the resource cooperative mode refers to a mode that executes an active application depending on resources of the user terminal.

Meanwhile, if it is determined in the step 302 that the input resource and other resources (e.g., calculation ability, battery and the like) are constrained, the process proceeds to step 312 and determines the user terminal as a type having constrains of an input interface and resources (e.g., as a IPTV or STB (set top box) type). Then, in step 314, an input interface adaptor of the TV terminal is driven. In step 316, the user terminal is set to the resource cooperative mode.

Meanwhile, if it is determined in the step 302 that the I/O resource and other resources of the user terminal are sufficient, the process proceeds to step 318 and determines the user terminal as a computer (PC) type having full interface.

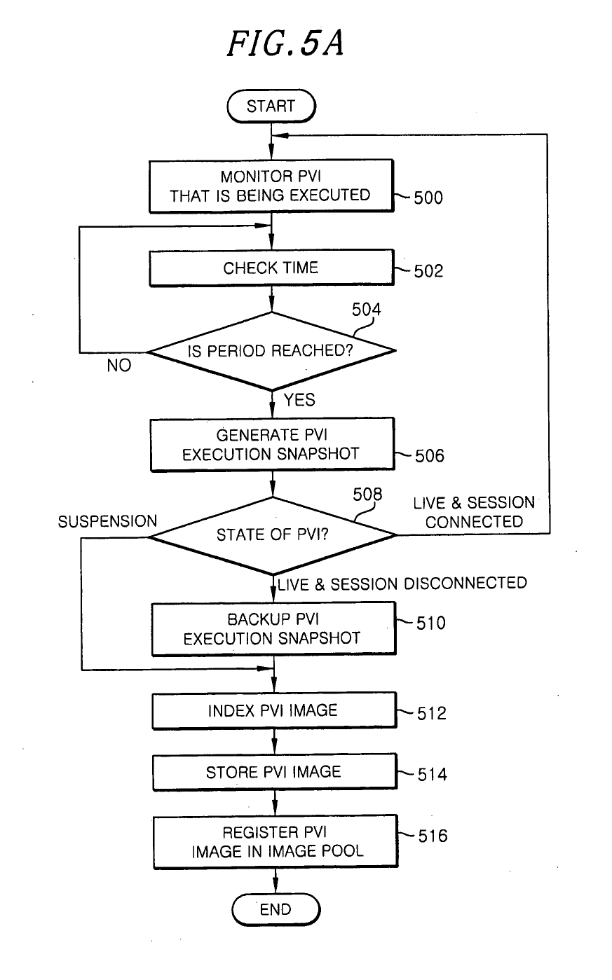

FIG. 4 is a flowchart showing an operation for provisioning a PVI of the PVI automatic provisioning shown in FIG. 2.

Referring to FIG. 4, in step 402, the PVI automatic provisioning 204 performs a waiting mode for waiting for a request for resource allocation from a user. If the request for resource allocation is received from the user in step 404, the process proceeds to step 406 and the PVI automatic provisioning 204 allocates to the user a hardware resource according to the request for resource allocation and further allocates to the user a private virtual machine having an operating system requested by the user.

Thereafter, in a state where the private virtual machine of the user has been booted, it is checked in step 408 whether or not a request for generating application exists on the private virtual machine of the user. If the request for generating application exists, the process proceeds to step 410 and the PVI automatic provisioning 204 performs provisioning of the application (application software) requested by the user in the private virtual machine. Next, the process proceeds to step 412. On the other hand, if it is determined in the step 408 that the request for generating application does not exist on the private virtual machine of the user, the process proceeds to step 412 to register a PVI lastly generated in an image pool within the PVI image manager 202. Then, in step 414, the PVI is provided to the user.

The provided PVI is stored in the image pool while maintaining the user's execution state.

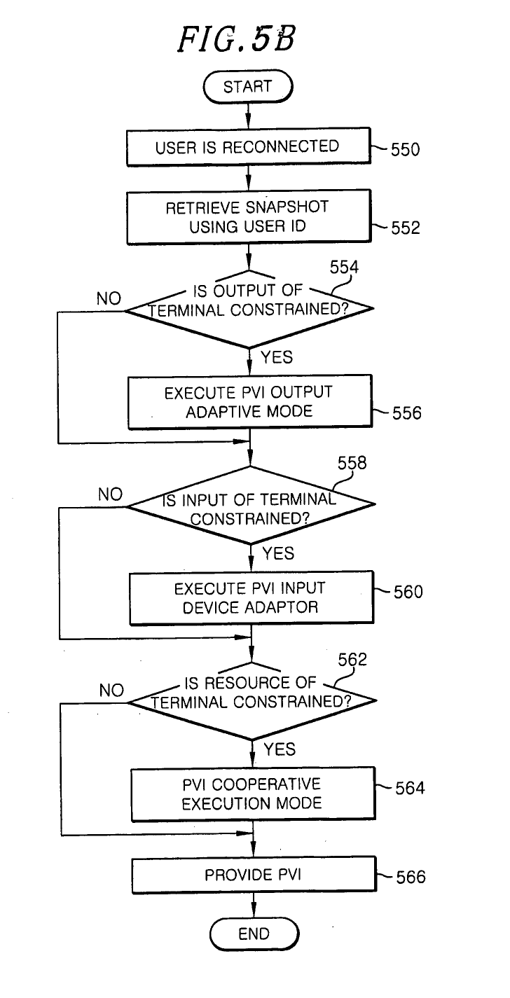

FIGS. 5A and 5B are flowcharts showing operations of the PVI image manager shown in FIG. 2.

Referring to FIG. 5A, in step 500, the PVI image manager 202 consistently monitors a PVI that is being executed. Time is checked in step 502 during the monitoring, and when a predetermined period is reached in step 504, i.e., at every predetermined period, the process proceeds to step 506 to generate an execution snapshot of the PVI.

Then, in step 508, a state of the PVI is checked. If it is checked that a session is connected in a state where the PVI is being executed, the process returns to the step 500 to perform continuous monitoring.

However, if it is checked in the step 508 that the session is disconnected in a state where the PVI is being executed, the process proceeds to step 510 to backup the execution snapshot of the PVI which has been generated in the step 506, and then proceeds to step 512. If it is checked in the step 508 that the PVI has been normally terminated by the user, the process proceeds directly to step 512. In the step 512, a PVI image of the execution snapshot is indexed, and in step 514, the PVI image is stored. In step 516, the PVI image is registered together with the state information of the PVI in the image pool within the PVI image manager 202 by using a user ID.

Referring to FIG. 5B, when the user is reconnected through the user terminal in step 550, the PVI image corresponding to the user ID is retrieved from the image pool within the PVI image manager 202 in step 552. Next, in step 554, a state of the user terminal is analyzed.

If it is determined that the output of the terminal is constrained from the analysis result in the step 554, the process proceeds to step 556 to execute on the terminal an adaptive mode for the PVI output, and then proceeds to step 558. If the constraint of the output device of the terminal is detected in the step 556, a device driver may be installed at the terminal. Here, said executing the adaptive mode for the PVI output on the terminal may include, e.g., making a screen smaller or making an interface simple if the terminal is a smart phone.

However, if it is determined that the output of the terminal is not constrained from the analysis result in the step 554, the process proceeds to step 558 and determines whether or not the input of the terminal is constrained. If it is determined in the step 558 that the input of the terminal is constrained, the process proceeds to step 560 to check the constraint of the input device of the terminal and install a device driver. Thereafter, the PVI input device adaptor is operated to perform an adaptive execution mode. Meanwhile, if it is determined in the step 558 that the input of the terminal is not constrained, the process proceeds directly to step 562.

Next, in the step 562, it is determined whether or not the resource of the terminal is constrained. If the resource of the terminal is constrained, the process proceeds to step 564 and set the application in the PVI to a dynamic cooperative execution mode between the user terminal and the PVI. The PVI which is reset is provided to the user in step 566. If the resource of the terminal is not constrained in the step 562, the process proceeds directly to the step 566 and the PVI is provided to the user.

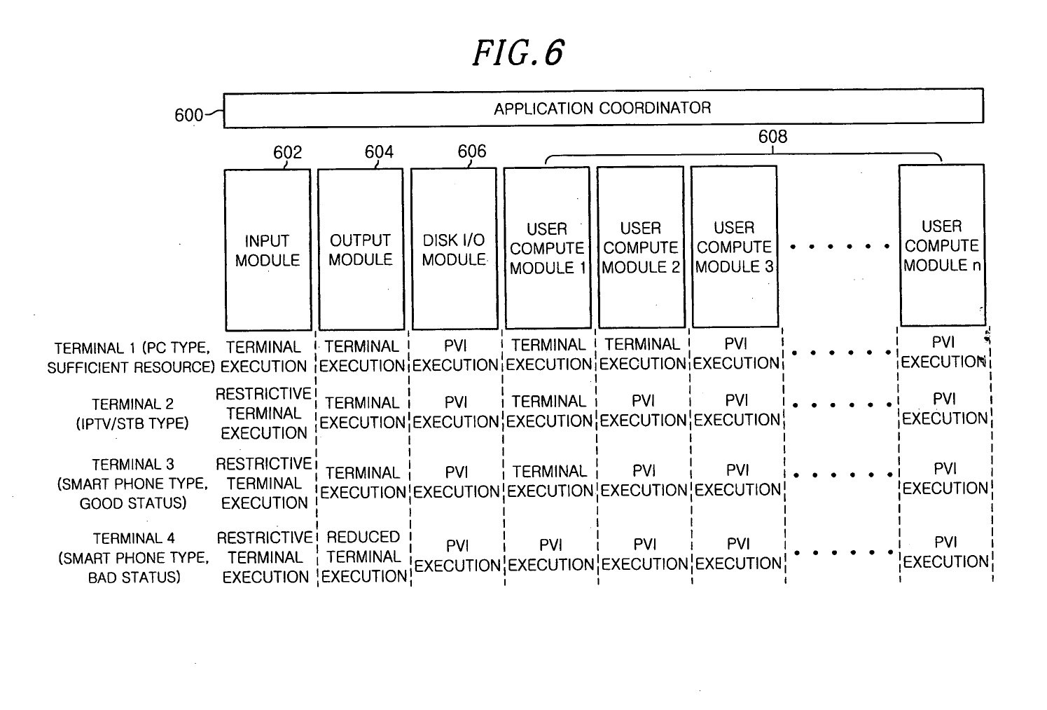

FIG. 6 shows a method in which the application software is executed cooperatively between the user terminal and the PVI depending on a type of a determined terminal in accordance with the embodiment of the present invention.

Referring to FIG. 6, when a storage resource and a compute of the user terminal are constrained, the adaptive application manager 206 allows the application software to be dynamically executed in the dynamic cooperative execution mode.

When the dynamic cooperative execution mode is set in the adaptive application manager 206, an application coordinator 600 analyzes the constraint of the resource of the connected user terminal. For a specific application, Hosts for execution are dynamically operated depending on their resources regarding an input module 602, an output module 604, a disc I/O module 606, and user compute modules 608 mainly using a CPU and a memory resource. In other words, if the terminal has sufficient resources, all compute modules 608 are executed on a terminal, and if the terminal has constrained resources, some of the compute modules 608 are executed on the PVI.

For example, in a terminal such as a computer having a sufficient resource, most of operations can be executed on the terminal without constraint. In a case of a terminal such as an IPTV/STB having a constrained input device, an input module suitable for the IPTV/STB is driven, and the user compute modules 608 may perform an application in a cooperative mode between the terminal and the PVI. Further, in a case of a terminal such as a smart phone having a constrained I/O device and a constrained compute resource, an adaptive module is driven for the I/O device of the terminal, and the compute modules 608 may variably change the position of execution between the terminal and the PVI according to the current state of the terminal.

Hence, the embodiment of the present invention can be used for constructing a mobile cloud system, a ubiquitous environment that is accessed by various terminals, or a 3-screen (IPTV, PC, smart phone) cloud system.

As described above, the adaptive mobile cloud system using a PVI and the construction method thereof in accordance with the embodiment of the present invention construct and uniquely manage a PVI for maintaining a hardware resource, an operating system, an application software and a user's execution state based on a user's demand in a mobile cloud computing system and allow equal access to the PVI through one or more heterogeneous terminals (IPTV, PC, smart phone, MID and the like).

While the invention has been shown and described with respect to the embodiments, various changes and modification may be made without departing from the scope of the invention. Therefore, the scope of the invention should be defined in accordance with the following claims and their equivalents without being limited to the above-described embodiments.

What is claimed is:

1. An adaptive mobile cloud system using a private virtual instance (PVI) comprising:
a PVI automatic provisioning for generating a PVI by providing a hardware resource, an operating system and an application which are requested by a user terminal;
a PVI image manager for storing and managing an image of an execution state of the PVI by checking a state of the PVI;
a mobile interface adaptor that is adaptively operated according to an input/output device and resources of the user terminal; and
an adaptive application manager for executing an application by adaptive cooperation between the user terminal and the PVI according to the resource of the user terminal.

2. The adaptive mobile cloud system of claim 1, wherein the PVI automatic provisioning generates and boots a virtual machine which has the hardware resource and the operating system requested by the user terminal; and registers, in an image pool of the PVI image manager, the PVI generated by installing the application selected by the user terminal and provides the PVI to the user terminal.

3. The adaptive mobile cloud system of claim 1, wherein the mobile interface adaptor checks whether the input/output device of the user terminal is constrained; checks whether the resources of the user terminal is constrained; and drives an interface adaptor adaptively according to the check results.

4. The adaptive mobile cloud system of claim 3, wherein the mobile interface adaptor drives an input interface adaptor of a television-type when it is checked that the input device and the resources of the user terminal are constrained; and sets the user terminal to a resource cooperative mode for performing an active execution of the application according to the resources of the user terminal.

5. The adaptive mobile cloud system of claim 3, wherein the mobile interface adaptor drives an input interface adaptor of a smart phone-type when it is checked the input/output device and the resources of the user terminal are constrained; sets the user terminal to a resource cooperative mode for performing an active execution of the application according to the resources of the user terminal; and changes the output device of the user terminal.

6. The adaptive mobile cloud system of claim 1, wherein the PVI image manager monitors a PVI which is being executed; and retrieves, when n^{th} reconnection occurs, an image of a final execution state of the PVI which is obtained at the time of n−1^{th} connection.

7. The adaptive mobile cloud system of claim 1, wherein the PVI image manager monitors the PVI at regular intervals; generates an execution snapshot of the PVI; backs up the generated execution snapshot when it is determined that a session is disconnected while the PVI being executed; indexes and stores an image of the snapshot of the PVI; and registers the image of the PVI in an image pool of the PVI image manager by using a user ID.

8. The adaptive mobile cloud system of claim 7, wherein the PVI image manager retrieves the image of the PVI corresponding to the user ID from the image pool when the user terminal is reconnected; operates the reconnected user terminal in an adaptive mode by checking whether the input/output device of the user terminal is constrained; and changes an environment of the PVI to provide the PVI having the changed environment to the user terminal.

9. The adaptive mobile cloud system of claim 8, wherein the PVI image manger installs a required device driver by checking a constraint of the input/output device of the user terminal; performs adaptation of the output device of the user terminal; and checks constraints of the resources of the user terminal to allow an application within the PVI to be executed in a cooperative execution mode between the user terminal and the PVI according to the constraints of the resources.

10. The adaptive mobile cloud system of claim 1, wherein the adaptive application manager checks a current state of the user terminal in a coordinator for adaptive application when it is determined that the resources of the user terminal are constrained; distributes user compute modules to the user terminal and the PVI according to a resource state of the user terminal; and shifts, according to changes in the state of the user terminal, some of the user compute modules from the user terminal to the PVI or from the PVI to the user terminal to execute them.

11. A method for constructing an adaptive mobile cloud system using a private virtual instance (PVI) comprising:
driving a mobile interface adaptor adaptively according to input/output device and resources of a user terminal;
generating a PVI by providing a hardware resource, an operating system and an application which are requested by the user terminal;
storing and managing an image of an execution state of the PVI by checking a state of the PVI; and
executing an application by adaptive cooperation between the user terminal and the PVI according to the resources of the user terminal.

12. The method of claim 11, wherein said generating the PVI includes:
generating and booting a virtual machine which has the hardware resource and the operating system requested by the user terminal; and
registering, in an image pool, the PVI generated by installing the application selected by the user terminal and providing the PVI to the user terminal.

13. The method of claim 11, wherein said driving the mobile interface adaptor includes:
checking whether the input/output device of the user terminal is constrained;
checking whether the resources of the user terminal is constrained; and
driving an interface adaptor adaptively according to the check results.

14. The method of claim 13, wherein said driving the mobile interface adaptor further includes:
driving an input interface adaptor of a television-type when it is checked that the input device and the resources of the user terminal are constrained; and
setting the user terminal to a resource cooperative mode for performing an active execution of the application according to the resources of the user terminal.

15. The method of claim 13, wherein said driving the mobile interface adaptor further includes:
driving an input interface adaptor of a smart phone-type when it is checked the input/output device and the resources of the user terminal are constrained;
setting the user terminal to a resource cooperative mode for performing an active execution of the application according to the resources of the user terminal; and
changing the output device of the user terminal.

16. The method of claim 11, wherein said storing and managing the image includes:
monitoring a PVI which is being executed; and
retrieving, when n^{th} reconnection occurs, an image of a final execution state of the PVI which is obtained at the time of n−1^{th} connection.

17. The method of claim 11, wherein said storing and managing the image further includes:
monitoring the PVI at regular intervals;
generating an execution snapshot of the PVI;
backing up the generated execution snapshot when it is determined that a session is disconnected while the PVI being executed;
indexing and storing an image of the snapshot of the PVI; and
registering the image of the PVI in an image pool by using a user ID.

18. The method of claim 17, wherein said storing and managing the image further includes:
retrieving the image of the PVI corresponding to the user ID from the image pool when the user terminal is reconnected;
operating the reconnected user terminal in an adaptive mode by checking whether the input/output device of the user terminal is constrained; and
changing an environment of the PVI to provide the PVI having the changed environment to the user terminal.

19. The method of claim 18, wherein said storing and managing the image further includes:
installing a required device driver by checking a constraint of the input/output device of the user terminal;
performing adaptation of the output device of the user terminal; and
checking constraints of the resources of the user terminal to allow an application within the PVI to be executed in a cooperative execution mode between the user terminal and the PVI according to the constraints of the resources.

20. The method of claim 11, wherein said executing an application includes:
checking a current state of the user terminal in a coordinator for adaptive application when it is determined that the resources of the user terminal are constrained;
distributing user compute modules to the user terminal and the PVI according to a resource state of the user terminal; and
shifting, according to changes in the state of the user terminal, some of the user compute modules from the user terminal to the PVI or from the PVI to the user terminal to execute them.
